(19) United States
(12) Patent Application Publication
(10) Pub. No.: US 2022/0128010 A1
(43) Pub. Date: Apr. 28, 2022

(54) STRUCTURE AND METHOD FOR COUNTER-ROTATING TURBINE AND GEAR ASSEMBLY AND DISASSEMBLY

(71) Applicant: GE Avio S.r.l., Turin (IT)

(72) Inventors: Roberto Maddaleno, Lanzo Torinese (IT); Andrea Depalma, Rivalta di Torino (IT); Antonio Giuseppe D'Ettole, Rivoli (IT); Matteo Renato Usseglio, Turin (IT)

(21) Appl. No.: 17/469,960

(22) Filed: Sep. 9, 2021

(30) Foreign Application Priority Data
Oct. 23, 2020 (IT) 102020000025183

(51) Int. Cl. F02C 7/36; F02C 7/06; F01D 25/24

(52) U.S. Cl. CPC F02C 7/36; F02C 7/06; F01D 25/243; F05D 2260/40311; F05D 2230/60; F05D 2260/30; F05D 2240/52

(57) ABSTRACT

A method for engine assembly is provided, the method including forming an interdigitated rotor assembly comprising an inner rotor assembly rotatable at a first speed different from an outer rotor assembly rotatable at a second speed; fastening a gear assembly to the interdigitated rotor assembly to form an interdigitated turbine assembly; and coupling the interdigitated turbine assembly to a gas generator, wherein coupling the interdigitated turbine assembly to the gas generator includes coupling a planet carrier assembly of the gear assembly to a static frame of the gas generator.

### PRIORITY INFORMATION

The present application claims priority to Italian Patent Application Number 102020000025183 filed on Oct. 23, 2020.

### FIELD

The present subject matter relates generally to turbine engine assembly and disassembly.

### BACKGROUND

Interdigitated turbine assemblies may provide improved operating efficiency over conventional non-interdigitated turbine assemblies. However, interdigitated turbine assemblies may generally be complex such as to adversely impact assembly and disassembly. Such adverse impact can further affect maintainability, repair, or application of geared interdigitated structures to gas turbine engines. As such, there is a need for structures and methods for interdigitated turbine and gear assembly and disassembly that improve installation, maintainability, and repair of engines with geared interdigitated structures.

### BRIEF DESCRIPTION

Aspects and advantages of the invention will be set forth in part in the following description, or may be obvious from the description, or may be learned through practice of the invention.

An aspect of the present disclosure is directed to a method for engine assembly. The method includes forming an interdigitated rotor assembly comprising an inner rotor assembly rotatable at a first speed different from an outer rotor assembly rotatable at a second speed; fastening a gear assembly to the interdigitated rotor assembly to form an interdigitated turbine assembly; and coupling the interdigitated turbine assembly to a gas generator, wherein coupling the interdigitated turbine assembly to the gas generator includes coupling a planet carrier assembly of the gear assembly to a static frame of the gas generator.

Another aspect of the present disclosure is directed to a method for engine disassembly, the method including unfastening, uninstalling, or uncoupling any two or more components fastened, installed, or coupled such as provided herein.

Yet another aspect of the present disclosure is directed to a turbomachine formed by the method of engine assembly provided herein. These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cutaway side view of an exemplary embodiment of a turbomachine engine including a core engine with a gear assembly according to an aspect of the present disclosure;

FIG. 2 is an exemplary schematic embodiment of the engine of FIG. 1 according to an aspect the present disclosure;

FIGS. 3-7 are partially exploded views of an interdigitated turbine assembly according to aspects of the present disclosure;

FIG. 8 is a schematic view of an interdigitated turbine assembly according to an aspect of the present disclosure;

FIG. 9 is a schematic view of an interdigitated turbine assembly according to an aspect of the present disclosure; and

FIGS. 10-15 are flowcharts outlining steps of a method for assembly and disassembly of an interdigitated turbine assembly and engine according to aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

One or more components of the turbomachine engine or gear assembly described herein below may be manufactured or formed using any suitable process, such as an additive manufacturing process, such as a 3-D printing process. The use of such a process may allow such component to be formed integrally, as a single monolithic component, or as any suitable number of sub-components. In particular, the additive manufacturing process may allow such component to be integrally formed and include a variety of features not possible when using prior manufacturing methods. For example, the additive manufacturing methods described herein may allow for the manufacture of gears, housings, conduits, heat exchangers, or other gear assembly components having unique features, configurations, thicknesses, materials, densities, fluid passageways, headers, and mounting structures that may not have been possible or practical using prior manufacturing methods. Some of these features are described herein.

Suitable additive manufacturing techniques in accordance with the present disclosure include, for example, Fused Deposition Modeling (FDM), Selective Laser Sintering (SLS), 3D printing such as by inkjets, laser jets, and binder jets, Stereolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

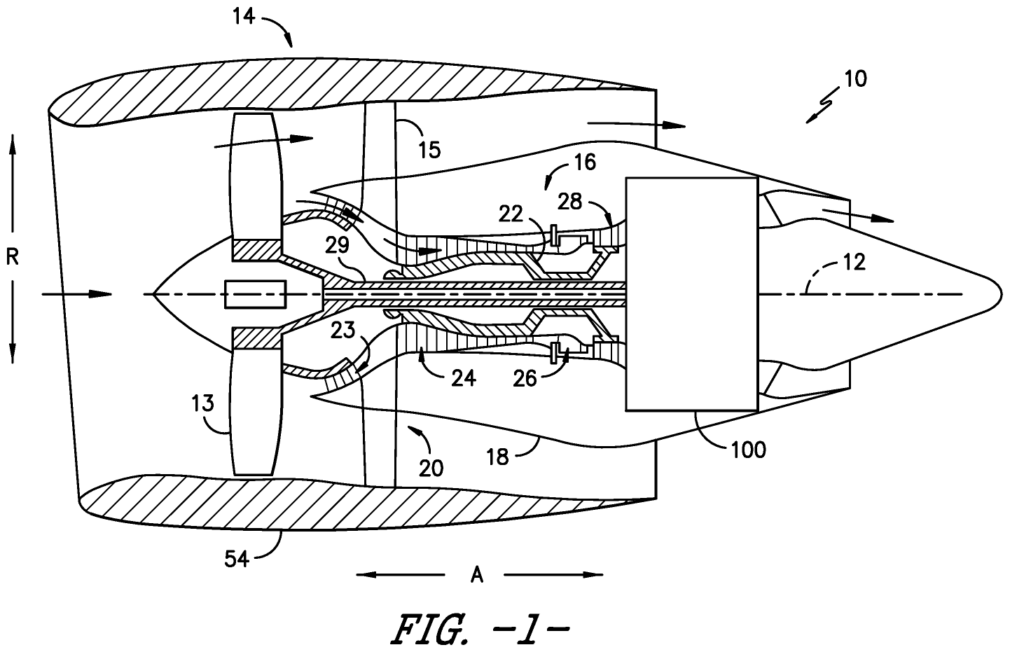

Referring now to the drawings, FIG. 1 is an exemplary embodiment of an engine 10 including a gear assembly according to aspects of the present disclosure. The engine 10 includes a fan assembly 14 driven by a core engine 16. In various embodiments, the core engine 16 is generally a Brayton cycle system configured to drive the fan assembly 14. The core engine 16 is shrouded, at least in part, by an outer casing 18. The fan assembly 14 includes a plurality of fan blades 13. A vane assembly 20 is extended from the outer casing 18. The vane assembly 20 including a plurality of vanes 15 is positioned in operable arrangement with the fan blades 13 to desirably alter a flow of air relative to the fan blades 13.

In certain embodiments, such as depicted in FIG. 1, the vane assembly 20 is positioned downstream or aft of the fan assembly 14. However, it should be appreciated that in some embodiments, the vane assembly 20 may be positioned upstream or forward of the fan assembly 14, such as in an open rotor fan configuration. In still various embodiments, the engine 10 may include a first vane assembly positioned forward of the fan assembly 14 and a second vane assembly positioned aft of the fan assembly 14. The fan assembly 14 may be configured to desirably adjust pitch at one or more fan blades 13, such as to control thrust vector, abate or re-direct noise, or alter thrust output. The vane assembly 20 may be configured to desirably adjust pitch at one or more vanes 15, such as to control thrust vector, abate or re-direct noise, or alter thrust output. Pitch control mechanisms at one or both of the fan assembly 14 or the vane assembly 20 may co-operate to produce one or more desired effects described above.

In certain embodiments, such as depicted in FIG. 1, the engine 10 is a turbofan gas turbine engine such that the plurality of fan blades 13 is shrouded by a nacelle or fan casing 54. In other embodiments, the engine 10 may be configured as an unshrouded turbofan engine, an open rotor engine, or a propfan engine. The engine 10 may include the fan assembly 14 having large-diameter fan blades 13, such as may be suitable for high bypass ratios, high cruise speeds, high cruise altitude, and/or relatively low rotational speeds.

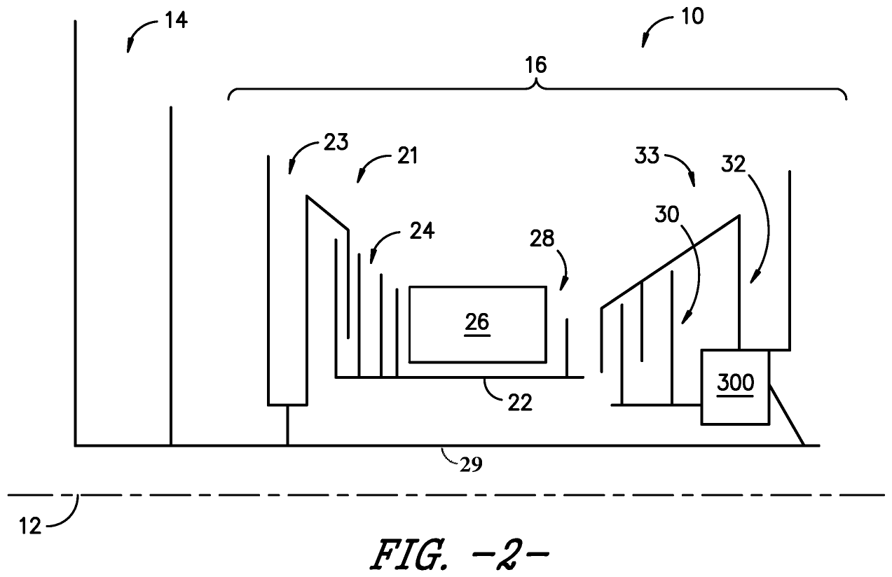

Referring now to FIG. 2, an exemplary embodiment of the core engine 16 is provided. The core engine 16 includes a compressor section 21, a heat addition system 26, and an expansion section 33 together in serial flow arrangement. In certain embodiments, the core engine 16 may include a third stream or compressor bypass flowpath. The core engine 16 is extended circumferentially relative to an engine centerline axis 12. The core engine 16 includes a high-speed spool that includes a high-speed compressor 24 and a high-speed turbine 28 operably rotatably coupled together by a high-speed shaft 22. The heat addition system 26 is positioned between the high-speed compressor 24 and the high-speed turbine 28. Various embodiments of the heat addition system 26 include a combustion section. The combustion section may be configured as a deflagrative combustion section, a rotating detonation combustion section, a pulse detonation combustion section, or other appropriate heat addition system. The heat addition system 26 may be configured as one or more of a rich-burn system or a lean-burn system, or combinations thereof. In still various embodiments, the heat addition system 26 includes an annular combustor, a can combustor, a cannular combustor, a trapped vortex combustor (TVC), or other appropriate combustion system, or combinations thereof.

Referring still to FIG. 2, the core engine 16 includes a booster or low-speed compressor 23 positioned in flow relationship with the high-speed compressor 24. The low-speed compressor 23 is rotatably coupled with the expansion section 33 via a first shaft 29. Various embodiments of the expansion section 33 further include a first turbine 30 and a second turbine 32 interdigitated with one another. The first turbine 30 and the second turbine 32 are each operably connected to a gear assembly 300 to provide power to the fan assembly 14 and the low-speed compressor 23, such as described further herein. In certain embodiments, the first turbine 30 and the second turbine 32 are together positioned downstream of the high-speed turbine 28.

It should be appreciated that the terms “low” and “high”, or their respective comparative degrees (e.g., -er, where applicable), when used with compressor, turbine, shaft, or spool components, each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine. Alternatively, unless otherwise specified, the aforementioned terms may be understood in their superlative degree. For example, a “low turbine” or “low speed turbine” may refer to the lowest maximum rotational speed turbine within a turbine section, a “low compressor” or “low speed compressor” may refer to the lowest maximum rotational speed turbine within a compressor section, a “high turbine” or “high speed turbine” may refer to the highest maximum rotational speed turbine within the turbine section, and a “high compressor” or “high speed compressor” may refer to the highest maximum rotational speed compressor within the compressor section. Similarly, the low speed spool refers to a lower maximum rotational speed than the high speed spool. It should further be appreciated that the terms “low” or “high” in such aforementioned regards may additionally, or alternatively, be understood as relative to minimum allowable speeds, or minimum or maximum allowable speeds relative to normal, desired, steady state, etc. operation of the engine.

In certain embodiments, such as depicted in FIG. 2, the core engine 16 includes one or more interdigitated structures at the compressor section 21 and/or the expansion section 33. In one embodiment, the expansion section 33 includes the second turbine 32 interdigitated with the first turbine 30, such as via a rotating outer shroud, drum, casing, or rotor. It should be appreciated that embodiments of the expansion section 33 may include the first and/or second turbine 30, 32 interdigitated with one or more stages of the high-speed turbine 28. In another embodiment, the compressor section 21 includes the low-speed compressor 23 interdigitated with the high-speed compressor 24. For instance, the higher speed compressor, such as the high-speed compressor 24, may be a first compressor interdigitated with the lower speed compressor, such as the low-speed compressor 23.

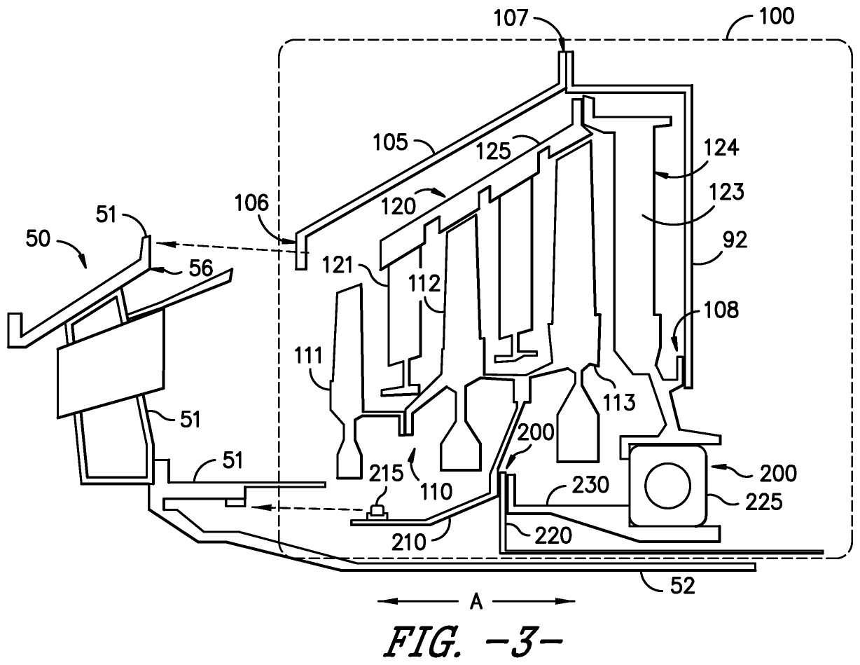

The core engine 16 includes a gas generator 50 (e.g., FIG. 3) formed by at least a portion of the compressor section 21, the heat addition system 26, and the high-speed turbine 28, such as depicted in FIG. 2. The gas generator 50 further includes static structures, frames, mounts, or other non-rotating portions, such as further described herein.

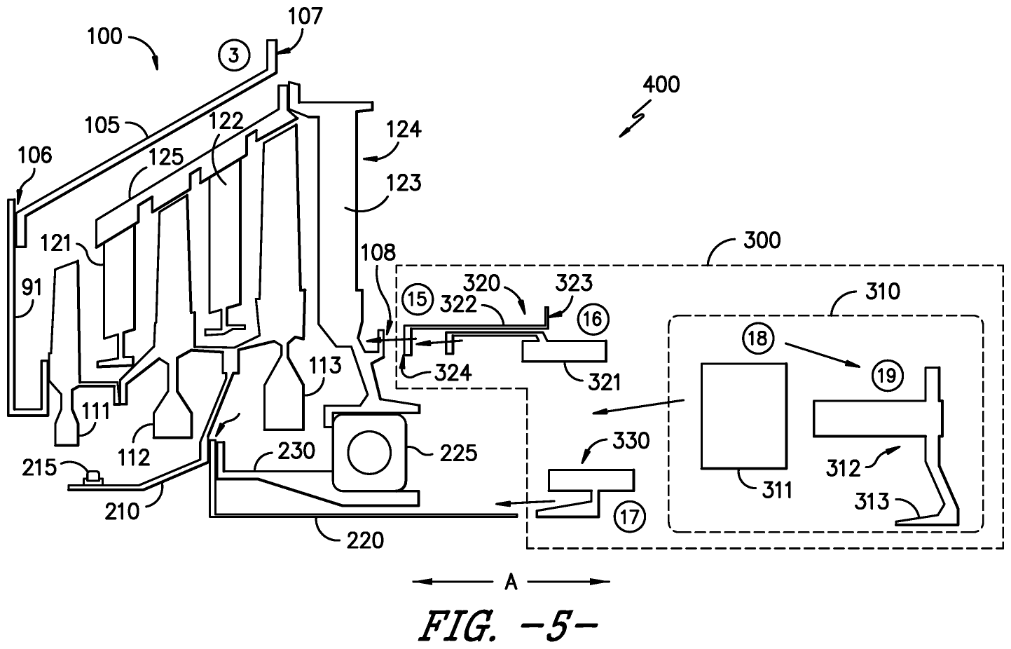

Referring now to FIG. 1 and FIG. 2, the core engine 16 includes the gear assembly 300 (FIG. 2) configured to transfer power from the expansion section 33 and reduce an output rotational speed at the fan assembly 14 relative to one or both turbines 30, 32 (FIG. 2). Embodiments of the gear assembly 300 depicted and described in regard to FIGS. 5-7 may allow for gear ratios suitable for large-diameter unducted fans and relatively small-diameter and/or relatively high-speed turbines, such as turbines 30, 32 (FIG. 2). Additionally, embodiments of the gear assembly 300 provided herein may be suitable within the radial or diametrical constraints of the core engine 16 within the outer casing 18.

Embodiments of the gear assembly 300 depicted and described in regard to FIGS. 5-9 may provide for gear ratios and arrangements that fit within the L/Dₘₐₓ constraints of the engine 10. In certain embodiments, the gear assembly 300 depicted and described allows for gear ratios and arrangements providing for rotational speed of the fan assembly 14 corresponding to one or more ranges of cruise altitude and/or cruise speed provided above. Various embodiments of the gear assembly 300 provided herein may allow for gear ratios of up to 14:1. Still various embodiments of the gear assembly 300 provided herein may allow for gear ratios greater than 1:1. In certain embodiments, the gear ratio is at least 3:1. Still yet various embodiments of the gear assembly 300 provided herein allow for gear ratios between 3:1 to 12:1 for an epicyclic gear assembly or compound gear assembly. The second rotor speed provided herein may be proportionally greater than the first rotor speed corresponding to the gear ratio, e.g., the second rotor speed generally greater than the first rotor speed, or 3× greater, or 7× greater, or 9× greater, or 11× greater, or up to 14× greater, etc. than the first rotor speed. It should be appreciated that embodiments of the gear assembly 300 provided herein may allow for large gear ratios such as provided herein between the expansion section 33 and the fan assembly 14, or particularly between a first turbine 30 (FIG. 2) and the fan assembly 14 and/or between a second turbine 32 (FIG. 2) and the fan assembly 14, and within constraints such as, but not limited to, length (L) of the engine 10, maximum diameter (Dₘₐₓ) of the engine 10, cruise altitude of up to 65,000 ft, and/or operating cruise speed of up to Mach 0.85, or combinations thereof.

Although depicted as an un-shrouded or open rotor engine, it should be appreciated that aspects of the disclosure provided herein may be applied to shrouded or ducted engines, partially ducted engines, aft-fan engines, or other turbomachine configurations, including those for marine, industrial, or aero-propulsion systems. Certain aspects of the disclosure may be applicable to turbofan, turboprop, or turboshaft engines, such as turbofan, turboprop, or turboshaft engines with reduction gear assemblies. However, it should be appreciated that certain aspects of the disclosure may address issues that may be particular to un-shrouded or open rotor engines, such as, but not limited to, issues related to gear ratios, fan diameter, fan speed, length (L) of the engine 10, maximum diameter (Dₘₐₓ) of the engine 10, L/Dₘₐₓ of the engine 10, desired cruise altitude, and/or desired operating cruise speed, or combinations thereof.

Referring now to FIGS. 3-7, exploded and partially exploded views of portions of an engine and an expansion section defining an interdigitated rotor assembly 100 are provided. The exploded views generally depict steps of a method for turbine assembly and engine assembly. Additionally, it should be appreciated that steps provided herein may be provided in particular sequences. Such sequences may be reversed, such as to provide a method for engine disassembly and turbine disassembly. Such sequences may allow for horizontal turbine and engine assembly, on-wing or on-aircraft turbine and engine assembly and disassembly, or portions thereof. Such sequences may substantially decrease engine complexity, improve cost of production and maintenance, and mitigate risks associated with operation and maintenance of counter-rotating turbine engines. However, it should be appreciated that particular steps may be performed in parallel or rearranged with other steps without affecting the scope of the disclosure.

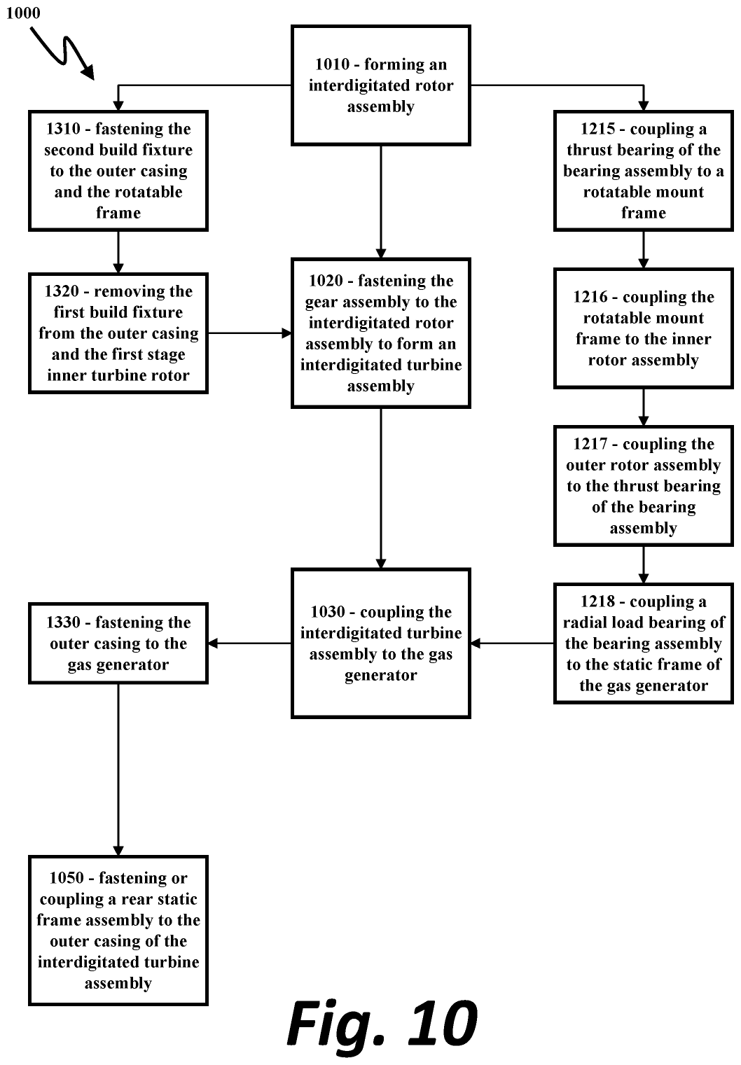

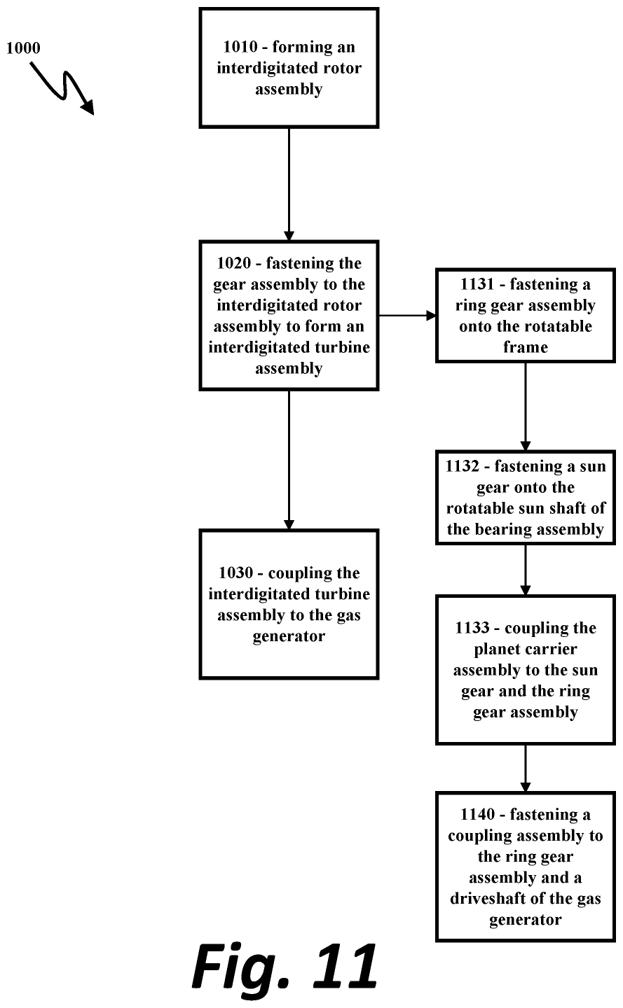

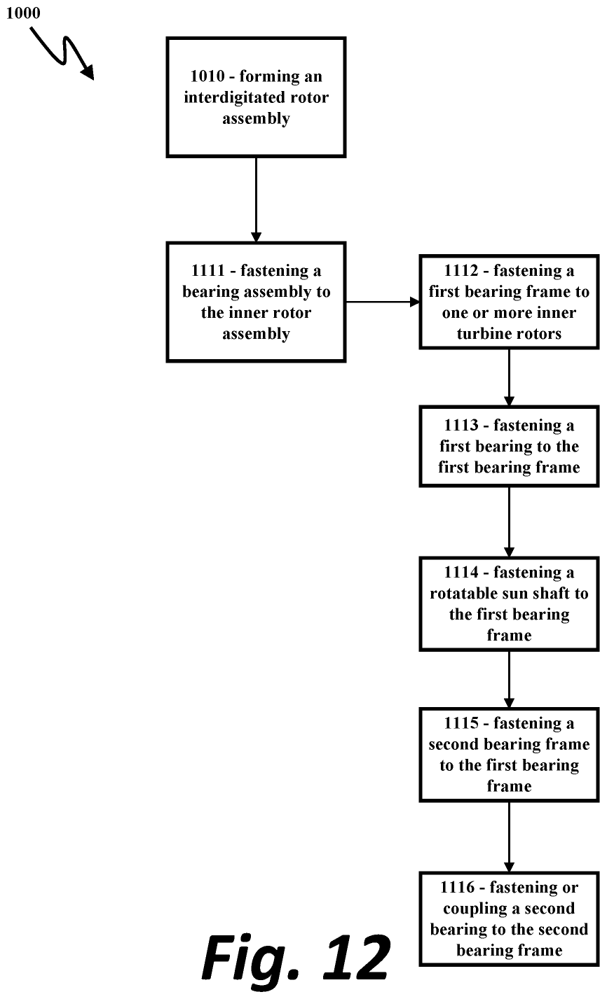

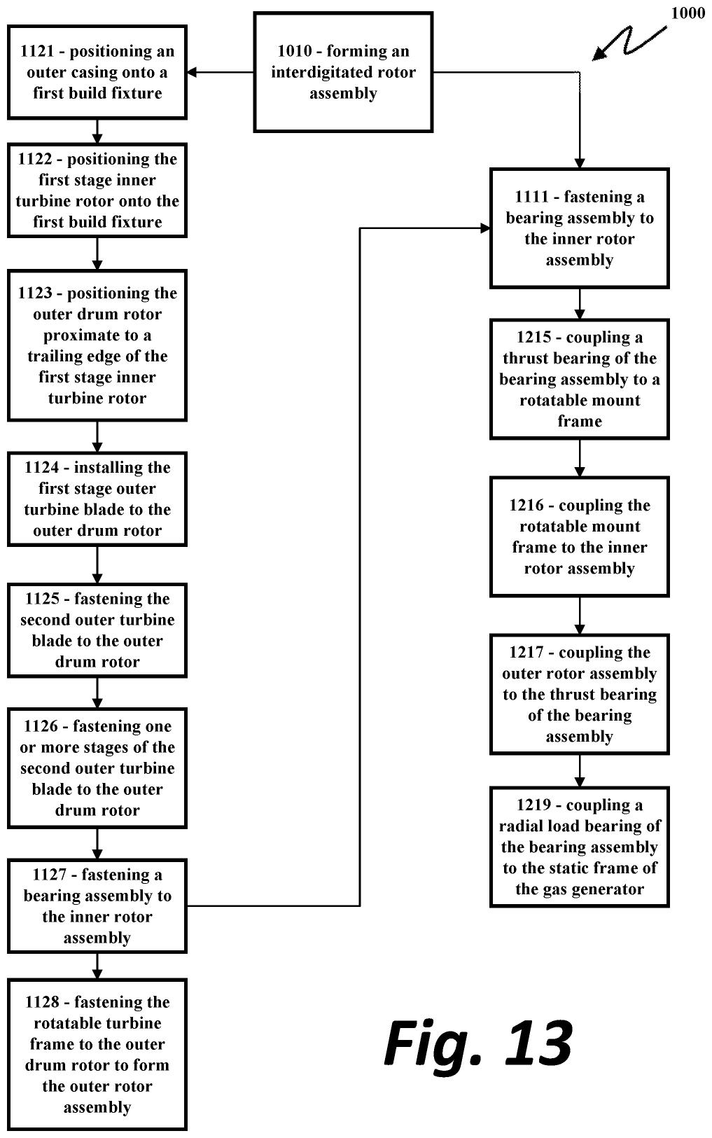

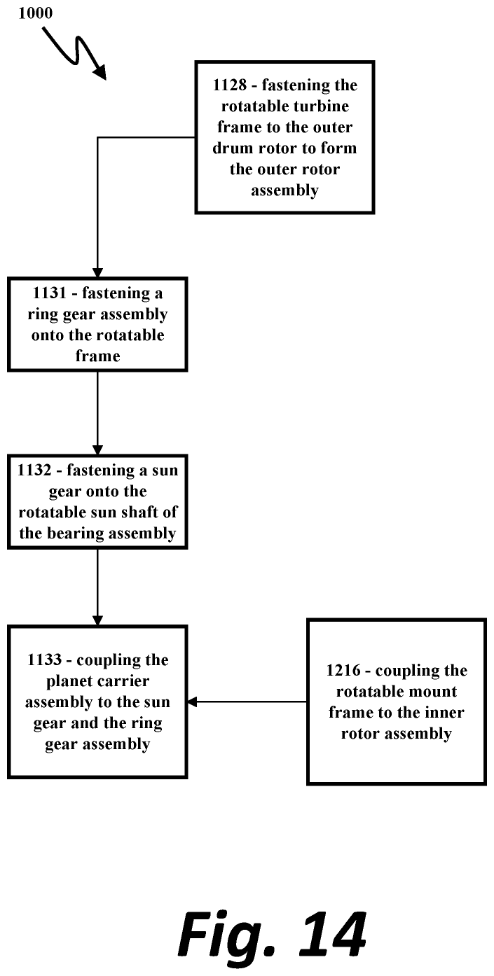

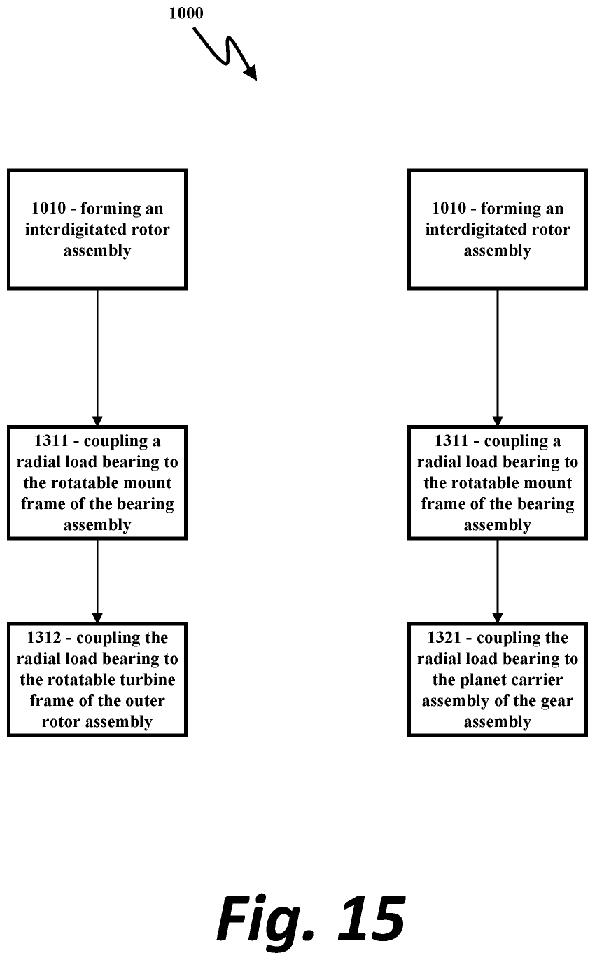

Referring also to FIGS. 10-15, a flowchart outlining steps for a method of turbine and engine assembly and disassembly (hereinafter, “method 1000”) is provided. It should be appreciated that although the flowchart provides steps in several figures, the method 1000 provided herein may include steps in certain sequential orders such as depicted and described herein. As provided above, steps provided herein may be provided in serial sequential order for assembly, and such sequences may be reversed for providing a method for turbine and engine disassembly. Furthermore, as provided herein, certain steps may be performed in parallel or rearranged with other steps without affecting the scope of the disclosure.

Referring to FIG. 3 and FIGS. 10-15, the method 1000 includes at 1010 forming an interdigitated rotor assembly, such as depicted in FIG. 3. The interdigitated rotor assembly includes an inner rotor assembly 110 rotatable at a first speed different from an outer rotor assembly 120 rotatable at a second speed. In various embodiments, the inner rotor assembly 110 includes the first turbine 30 and the outer rotor assembly 120 includes the second turbine 32 depicted in FIG. 2. The interdigitated rotor assembly 100 includes a static casing or frame 105 surrounding the outer rotor assembly 120. In various embodiments, the frame 105 is an annular frusto-conical structure. The frame 105 may extend as the annular frusto-conical structure from an inner radius forward end 106 to an outer radius aft end 107. The interdigitated rotor assembly 100 includes two or more stages or axially-separated rows of separately rotatable turbine blades. The inner rotor assembly 110 includes one or more rotors (e.g., integrally bladed disks, machined castings, composite structures, blade-and-drum assemblies, etc.) attached to one another. The outer rotor assembly 120 includes a rotatable outer drum 125 at which one or more stages of outer turbine blades is attached. The outer rotor assembly 120 further includes a rotatable turbine frame 124 connected to the outer drum 125. The rotatable turbine frame 124 includes a plurality of blades 123 providing structural support to the outer drum 125 and outer turbine blades. The plurality of blades 123 of the rotatable turbine frame 124 may further include aerodynamic contours for extracting energy from combustion gases. The rotatable turbine frame 124 and the inner rotor assembly 110 are together connected to a bearing assembly 225.

In a particular embodiment, a build fixture 92 is attached to the aft end 107 of the static casing or frame 105 of the interdigitated rotor assembly 100. The build fixture 92 is further attached to a connection interface or flange 108 at the rotatable turbine frame 124. In certain embodiments including a build fixture (i.e., first build fixture 91) attached to the forward end 106 of the frame 105, the second build fixture 92 is attached and the first build fixture 91 is removed to allow the interdigitated rotor assembly 100 to attach to the static frame 51 of the gas generator 50. In certain embodiments, the method 1000 includes at 1310 fastening the second build fixture 92 to the outer casing 105 and the rotatable turbine frame 124. The method 1000 may further include at 1320 removing the first build fixture 91 from the outer casing 105 and the first stage inner turbine rotor 111. The method 1000 may still further include at 1330 fastening the outer casing 105 to the gas generator 50.

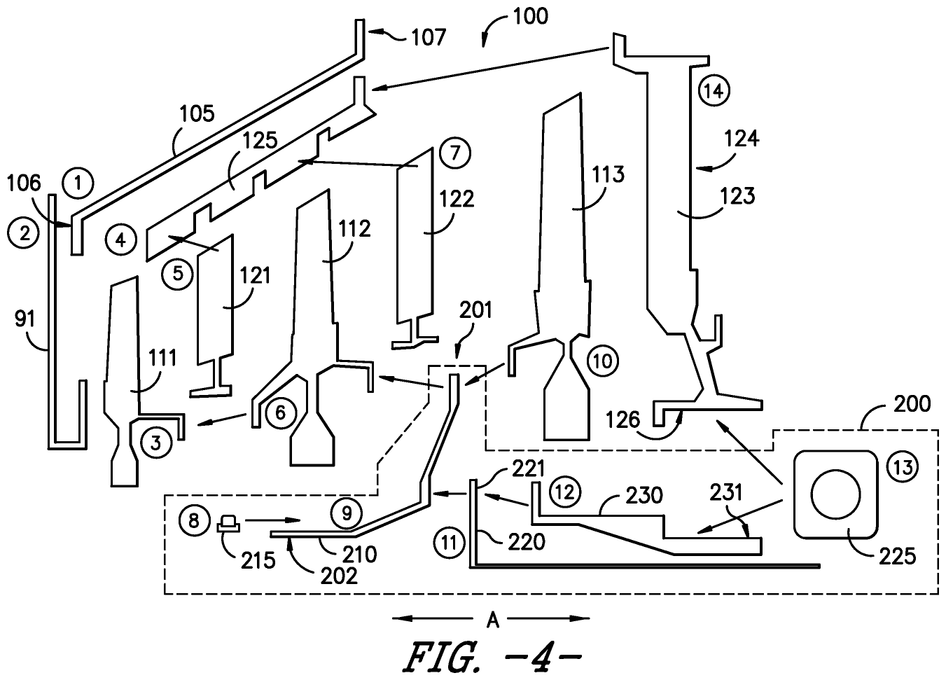

Referring now to FIG. 4, an exploded view of the interdigitated rotor assembly 100 is provided. The inner rotor assembly 110 includes a first stage inner turbine rotor 111 and the outer rotor assembly 120 includes a row of first stage outer turbine blade 121. In certain embodiments, the inner rotor assembly 110 includes a plurality of stages of inner turbine rotor aft or downstream of the first stage inner turbine rotor 111, such as depicted at inner turbine rotors 112, 113. Although depicted herein as three stages of inner turbine rotors, it should be appreciated that the inner rotor assembly 110 may include one or more stages of inner turbine rotor generally (e.g., including only rotor 111, or additionally rotor 112, or furthermore rotor 113, or additional rotors not shown).

In still certain embodiments, the outer rotor assembly 120 includes a plurality of stages of outer turbine blades aft or downstream of the first stage outer turbine blade 121, such as depicted at blade row 122. However, it should be appreciated that in one embodiment, the rotatable turbine frame 124 is positioned in place of the blade row 122 (e.g., the outer rotor assembly 120 including two stages via the first stage outer turbine blade 121 and the rotatable turbine frame 124). In other embodiments, the outer rotor assembly 120 includes a plurality of stages of the blade row 122. In still certain embodiments, the rotor assembly 100 includes a plurality of iterations of inner turbine rotors (e.g., inner turbine rotors 112, 113) and blade rows 122 with the rotatable turbine frame 124 positioned at the aft end of the rotor assembly 100. For example, the outer rotor assembly 120 includes the first stage outer turbine blade 121, and one or more additional stages of blade rows 122 between the first stage outer turbine blade 121 and the rotatable turbine frame 124. In certain embodiments, the outer rotor assembly 120 includes a second stage blade row and a third stage blade row upstream of the rotatable turbine frame 124.

In particular embodiments of the method 1000 at 1010, forming the interdigitated rotor assembly further includes at 1111 fastening a bearing assembly to the inner rotor assembly. In some embodiments, the step at 1111 is further encompassed at the step at 1127 further provided herein. The interdigitated rotor assembly 100 includes a bearing assembly 200 fastened or connected to one or more rotors of the inner rotor assembly 110. In one embodiment, such as depicted in FIG. 4, the bearing assembly 200 is fixed between a pair of rotors, such as between inner turbine rotors 112, 113. In still particular embodiments, forming the interdigitated rotor assembly 100 includes at 1112 fastening a first bearing frame 210 to one or more inner turbine rotors. In one embodiment, the first bearing frame 210 provides a flange 201 extended to allow a portion of the first bearing frame 210 to be positioned and fastened between two or more inner turbine rotors (e.g., inner turbine rotors 112, 113).

In certain embodiments of the method 1000 at 1010, forming the interdigitated rotor assembly further includes at 1113 fastening a first bearing to the first bearing frame. The first bearing frame 210 further includes an annular surface 202 at which a first bearing 215 is attached. In certain embodiments, the first bearing 215 is a radial load bearing, such as a roller bearing, a tapered roller bearing, or other appropriate bearing configuration. The first bearing frame 210 is extended forward along an axial direction A toward the gas generator 50, such as further described herein. One or more portions of the first bearing 215, such as an outer bearing race, may be positioned and fixed to the gas generator 50, or particularly a static frame 51 of the gas generator 50 (FIG. 3). In a particular embodiment, the method 1000 includes at 1213 coupling a radial load bearing of the bearing assembly to the static frame of the gas generator, such as described in regard to the first bearing 215.

In still particular embodiments of the method 1000 at 1010, forming the interdigitated rotor assembly further includes at 1114 fastening a rotatable sun shaft to the first bearing frame. A rotatable sun shaft 220 is extended from the first bearing frame 210 toward a gear assembly 300 (FIG. 5). In one embodiment, such as depicted in FIG. 4, the sun shaft 220 is extended aft along the axial direction A toward the gear assembly 300. The sun shaft 220 may include an axially extended portion 221 at which the sun shaft 220 attaches, fastens, or otherwise connects to the first bearing frame 210.

In various embodiments of the method 1000 at 1010, forming the interdigitated rotor assembly further includes at 1115 fastening a second bearing frame to the first bearing frame. The bearing assembly 200 includes a second bearing frame 230 at which a second bearing 225 is attached. The second bearing frame 230 further includes an annular surface 231 at which the second bearing 225 is attached. In certain embodiments, the second bearing 225 is a thrust bearing, such as a ball bearing or other appropriate bearing configuration configured for loads along the axial direction A and radial loads generally perpendicular or oblique to the axial direction A. The second bearing frame 230 is extended forward along the axial direction A toward the gear assembly 300, such as further described herein.

In certain embodiments, the method 1000 includes at 1215 coupling a thrust bearing of the bearing assembly to a rotatable mount frame. The method 1000 may further include at 1216 coupling the rotatable mount frame to the inner rotor assembly. In one embodiment, the second bearing 225 is the thrust bearing, or another suitable bearing configuration for loads along the axial direction A, such as described herein. In another embodiment, the rotatable mount frame is the second bearing frame 230 such as described above. It should be appreciated that the rotatable mount frame is fixed to the inner rotor assembly 110, such as via the bearing assembly 200 as depicted and described herein.

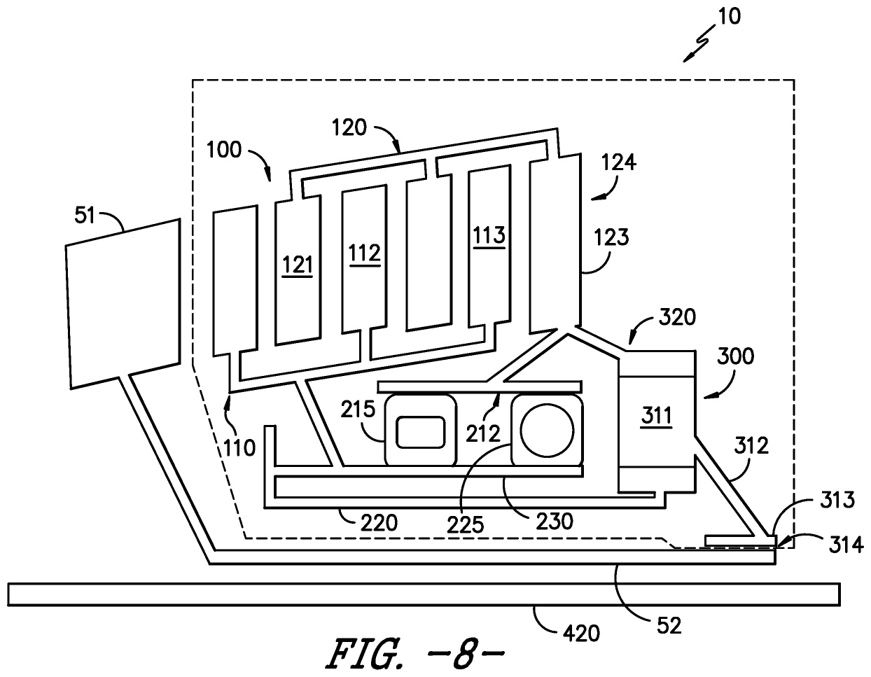

In some embodiments of the method 1000 at 1010, forming the interdigitated rotor assembly further includes at 1116 fastening or coupling a second bearing to the second bearing frame. The bearing assembly 210 includes the second bearing 225 such as described herein. In one embodiment, the second bearing 225 is attached to the second bearing frame 230 then attached to the rotatable turbine frame 124. In another embodiment, the second bearing 225 is attached to the rotatable turbine frame 124 then to the second bearing frame 230. In a particular embodiment, the method 1000 includes at 1217 coupling the outer rotor assembly 120 to the thrust bearing 225 of the bearing assembly 200. In such an embodiment, the outer rotor assembly 120 is coupled to the inner rotor assembly 110 via the thrust bearing 225, such as described herein. In certain embodiments, the method 1000 at 1216 includes coupling one or more bearings, such as the second bearing 225 defining the thrust bearing, of the bearing assembly 200 to the outer rotor assembly 120 and the inner rotor assembly 110 to define the one or more bearings as one or more inter-rotor bearings (i.e., a bearing positioned between and coupled to two rotor structures). In another embodiment, such as depicted in FIG. 8, the method 1000 at 1216 includes coupling the first bearing 215 defining the radial load bearing and the second bearing 225 defining the thrust bearing to the outer rotor assembly 120 and the inner rotor assembly 110 to define bearings as inter-rotor bearings.

It should be appreciated that the bearing assembly 200 may be sub-assembly all or partially assembled together prior to attaching the bearing assembly 200 to the inner rotor assembly 110. In one embodiment, the first bearing 215, the first bearing frame 210, the sun shaft 220, and the second bearing frame 230 are assembled as a sub-assembly to the inner rotor assembly 110. In certain embodiments, the inner turbine rotor 113 is then attached to the inner rotor assembly 110 and the bearing assembly 200, such as at flange 201 of the bearing assembly 200. In various embodiments, the method 1000 includes at 1218 coupling a radial load bearing, such as the first bearing 215, of the bearing assembly to the static frame of the gas generator, such as described herein. In still certain embodiments, the second bearing 225 is then attached to the second bearing frame 230. In a certain embodiment, the method 1000 includes at 1217 coupling the outer rotor assembly to the thrust bearing of the bearing assembly, such as described herein.

In a particular embodiment of the method 1000 at 1010, forming the interdigitated rotor assembly further at includes at 1121 positioning an outer casing 105 onto a first build fixture 91, such as depicted at FIG. 4. The first build fixture 91 is positioned at a forward end of the rotor assembly 100. The first build fixture 91 is configured to position a forward end 106 of the static casing or frame 105 onto the first build fixture 91. The first build fixture 91 positions the frame 105 in relation to the first stage inner turbine rotor 111. The method 1000 at 1010 may then further include at 1122 positioning the first stage inner turbine rotor 111 onto the first build fixture 91, then at 1123 positioning the outer drum rotor 125 proximate to a trailing edge of the first stage inner turbine rotor 111, such as depicted in FIG. 4.

In an embodiment, the method 1000 then further includes at 1124 installing the first stage outer turbine blade 121 to the outer drum rotor 125. The method 1000 then includes at 1125 fastening the second stage inner turbine rotor 112 to the first stage inner turbine rotor 111 to form, at least in part, the inner rotor assembly 110. The method 1000 may then further include at 1126 fastening the second outer turbine blade 122 to the outer drum rotor 125, such as described herein. The method 1000 may then further include at 1127 fastening the bearing assembly 200 to the inner rotor assembly 110, and then at 1128 fastening the rotatable turbine frame 124 to the outer drum rotor 125 to form the outer rotor assembly 120.

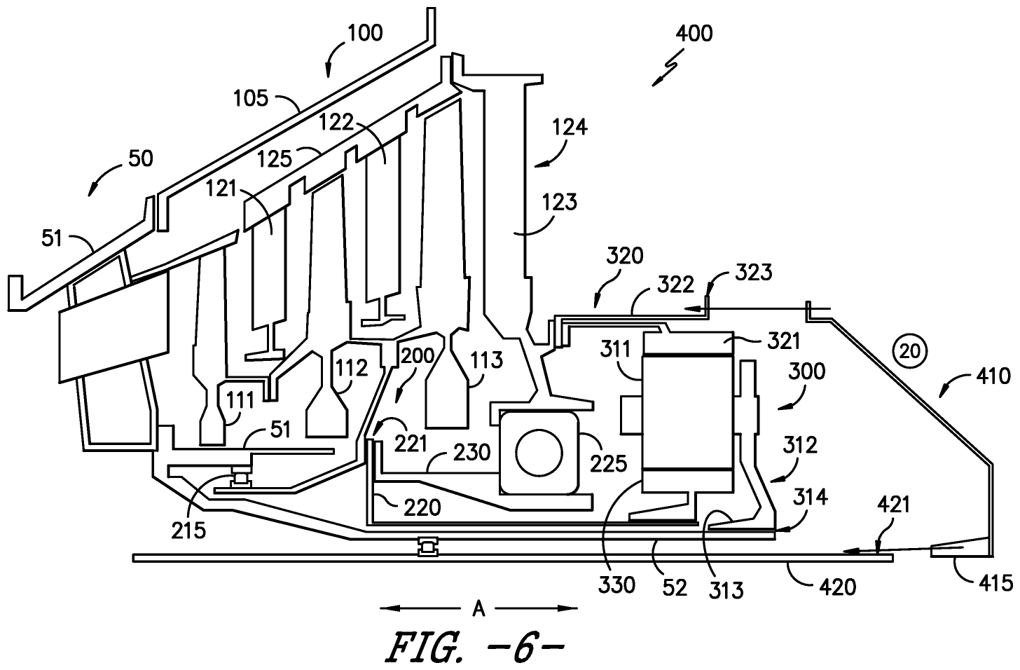

Referring now to FIGS. 5-6, in conjunction with FIGS. 10-15, the method 1000 includes at 1020 fastening the gear assembly 300 to the interdigitated rotor assembly 100 to form an interdigitated turbine assembly 400. In certain embodiments, the gear assembly 300 may be pre-assembled, at least in part, separately and then connected to the interdigitated rotor assembly 100. In other embodiments, portions of the gear assembly 300 such as described herein are formed onto the interdigitated rotor assembly 100. It should be appreciated that forming the gear assembly 300 onto the rotor assembly 100 may allow for detailed assembly and disassembly of particular components of the engine 10. Such detailed assembly and disassembly may improve an ability to maintain or repair particular portions of the gear assembly 300 and rotor assembly 100, e.g., without removing the rotor assembly 100 from the gas generator, or without removing the entire interdigitated turbine assembly 400 from the engine 10.

In a particular embodiment, fastening or coupling the gear assembly 300 to the interdigitated rotor assembly 100 includes at 1131 fastening a ring gear assembly 320 onto the rotatable turbine frame 124. In various embodiments, the ring gear assembly 320 includes a ring gear 321 and an output shaft 322. The output shaft 322 includes a connection interface or flange 323 at which a coupling assembly 410 (FIG. 6) attaches. The ring gear assembly 320 may generally include an interface 324 at which the ring gear 321 and the output shaft 322 attach to the rotatable turbine frame 124. In a particular embodiment, the ring gear assembly 320 attaches at the interface 324 to the connection interface or flange 108 of the rotatable turbine frame 124.

In a particular embodiment, fastening or coupling the gear assembly 300 to the interdigitated rotor assembly 100 includes at 1132 fastening a sun gear 330 onto the rotatable sun shaft 220 of the bearing assembly 200. In certain embodiments, the sun gear 330 and sun shaft 220 together define a spline interface at which the sun gear 330 and sun shaft 220 are connected. It should be appreciated that in some embodiments the sun shaft 220 may include a spline interface defining the sun gear 330 at which a planet carrier assembly 310 is coupled.

In various embodiments, fastening or coupling the gear assembly 300 to the interdigitated rotor assembly 100 includes at 1133 coupling the planet carrier assembly 310 to the sun gear 220 and the ring gear assembly 320. The planet carrier assembly 310 includes a plurality of planet gears 311 and a carrier 312. The carrier 312 is configured to fix the planet gears 311 in circumferential arrangement. The planet carrier assembly 310 is fixed relative to rotation along a circumferential direction or engine centerline axis 12 (FIG. 1). The planet carrier assembly 310 may further include a spline interface 314 configured to fix to the static structure 52.

Referring back to FIGS. 10-15, and in conjunction with FIGS. 5-6, the method 1000 includes at 1030 coupling the interdigitated turbine assembly 400 to the gas generator 50. In certain embodiments, coupling the interdigitated turbine assembly 400 to the gas generator 50 includes coupling the planet carrier assembly 310 of the gear assembly 300 to the static frame 51 of the gas generator 50. In one embodiment, the static frame 51 includes an axially extended shaft or frame 52 extended aft toward the gear assembly 300. In a particular embodiment, coupling the interdigitated turbine assembly 400 to the gas generator 50 includes coupling the planet carrier assembly 310 to the static frame 51 of the gas generator 50 via a spline interface 314 (FIG. 6). The static frame 51, such as at the spline interface 314, provides allows the gear assembly 300 and rotor assembly 100 to be statically determinate, such that the static frame 51 allows loads to transfer from the inner rotor assembly 110 through the sun gear 330 and the planet gears 311 to the ring gear 321 rotatable with the outer rotor assembly 120.

In various embodiments, such as depicted in FIG. 6, the method 1000 may include at 1140 fastening or coupling the coupling assembly 410 to the ring gear assembly 320 and a driveshaft 420 connected to the fan assembly 14 (such as depicted as first shaft 29 in FIG. 1). In certain embodiments, the coupling assembly 410 is a flexible coupling such as to allow a desired magnitude of torsion between the gear assembly 300 and the fan assembly 14 (FIG. 1) connected to the driveshaft 420. In particular embodiments, the coupling assembly 410 and the driveshaft 420 together include a splined interface 415 to connect and transfer loads between the coupling assembly 410 and the driveshaft 420.

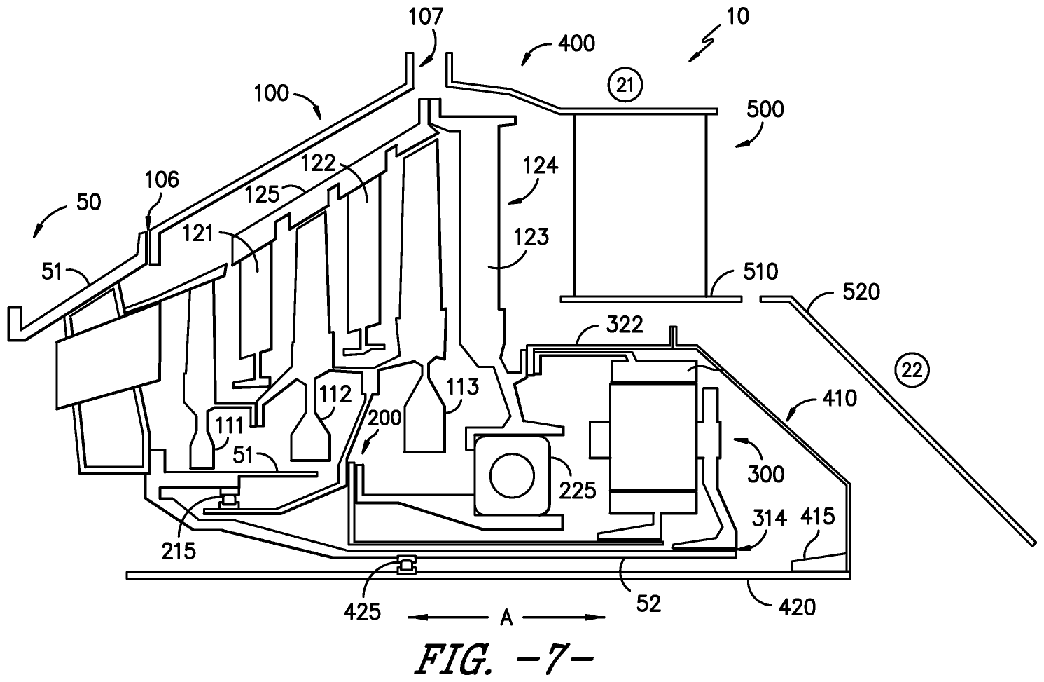

Referring now to FIG. 7, the method 1000 may further include at 1050 fastening or coupling a rear static frame assembly 500 to the outer casing 105 of the interdigitated turbine assembly 400. The rear static frame assembly 500 generally includes a frame 510 including a plurality of vanes and a cap 520 to cover or obscure the gear assembly 300 and coupling assembly 410.

Referring now to FIG. 8, another exemplary embodiment of the engine 10 including the interdigitated turbine assembly 400 is provided. The turbine assembly 400 and engine 10 are assembled substantially similarly as depicted and described in regard to FIGS. 1-7. In FIG. 8, the first bearing 215 defining the radial load bearing is positioned at a bearing interface surface 116 of the rotatable turbine frame 124. The first bearing 215 is further coupled to the rotatable mount frame, such as the bearing frame 230, such as to couple the radial load bearing to the rotatable mount frame of the bearing assembly 200 and the rotatable turbine frame 124 of the outer rotor assembly 120, such as described herein. The method 1000 at 1010 may further include at 1311 coupling a radial load bearing to the rotatable mount frame of the bearing assembly. The method 1000 at 1010 may further include at 1312 coupling the radial load bearing to the rotatable turbine frame of the outer rotor assembly, such as described herein.

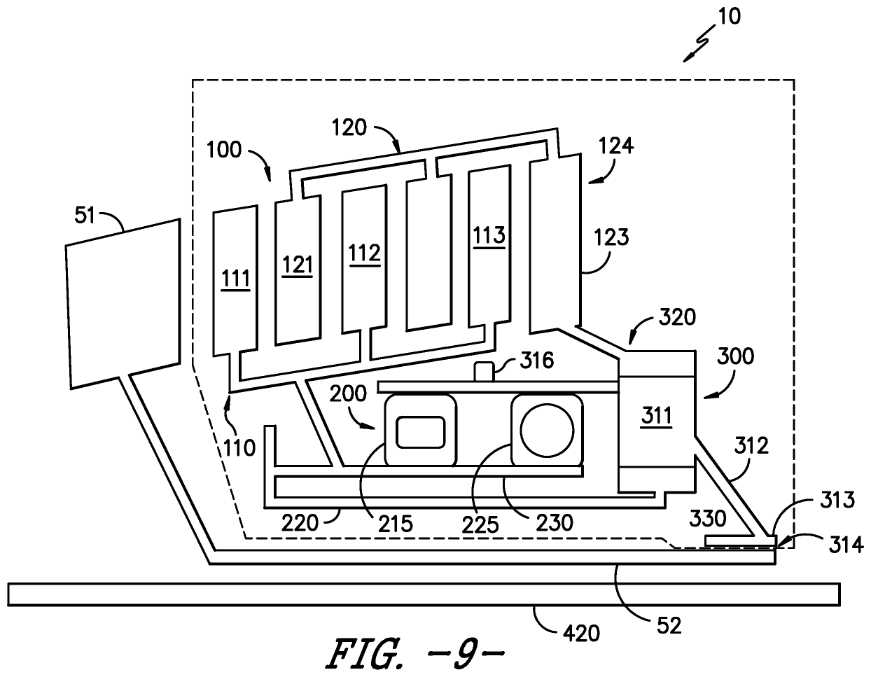

Referring now to FIG. 9, another exemplary embodiment of the engine 10 including the interdigitated turbine assembly 400 is provided. The turbine assembly 400 and engine 10 are assembled substantially similarly as depicted and described in regard to FIGS. 1-7. In FIG. 9, the first bearing 215 defining the radial load bearing is positioned at a bearing interface surface 316 of the planet carrier assembly 310. The second bearing 225 defining the thrust bearing is further positioned at the bearing interface surface 316 of the planet carrier assembly 310. The first bearing 215 and the second bearing 225 are each coupled to the rotatable mount frame, such as the bearing frame 230. As such, the radial load bearing and the thrust bearing are each coupled to the rotatable mount frame of the bearing assembly 200 and to the static planet carrier assembly 310. The method 1000 at 1010 may further include at 1311 coupling a radial load bearing to the rotatable mount frame of the bearing assembly. The method 1000 at 1020 may further include at 1321 coupling the radial load bearing to the planet carrier assembly of the gear assembly.

It should be appreciated that, in various embodiments, fastening or coupling components together such as described herein may include mechanical fasteners (e.g., bolts, nuts, nut plates, tie rods, screws, etc.), interference fits (e.g., a fit between two components in which an external dimension of a first component exceeds an internal dimension of a second component into which the components are coupled), spline or gear meshes, or other joining methods. Fastening or coupling may particularly include methods for joining two or more components such that they are separable and re-joinable for disassembly and assembly. Certain interfaces, such as flanges (e.g., flange 108, 201, 323, 324, etc.) described herein, may be joined to one another via mechanical fasteners. Although not described in detail, certain components may include seals, sealants, springs, etc. Such seals, sealants, springs, etc. may be positioned particularly at an interface of the blades, such as outer turbine blades 121, 122, and the outer drum 125 and/or inner rotor assembly 110.

Certain interfaces may particularly include interference fits, such as interfaces at which the bearings 215, 225, 425 are coupled or fastened, spline interfaces, or gear meshes. It should be appreciated that all or part of the bearing may be installed onto one surface (e.g., an inner race) and another portion may be installed onto a mating surface (e.g., an outer race). Interference fits may generally include an application of heat to one or more surfaces, such as to expand a dimension, and/or removal of heat (e.g., cooling or icing) to one or more other surfaces, such as to contract a dimension, to facilitate coupling or fastening.

Various embodiments of the rotor assembly 100, turbine assembly 400, and engine 10 provided herein, and methods 1000 for assembly and disassembly thereof, may particularly include the first bearing 215 having a first radial bearing portion (e.g., an inner bearing race) at a first surface (e.g., the first bearing frame 210 or the second bearing frame 220) and a second radial bearing portion (e.g., an outer bearing race) at a second surface (e.g., the static frame 51, the bearing interface surface 116 at the rotatable turbine frame 124, the bearing interface surface 316 at gear assembly). Furthermore, embodiments provided herein may particularly include the spline interface 314 at the static frame 51 and planet carrier assembly 310. Still further, embodiments provided herein may particularly include the second bearing 225 defining the thrust bearing being positioned between the outer rotor assembly 120 and the inner rotor assembly 110.

Embodiments depicted and described herein may include benefits over known structures and methods for assembly and disassembly for non-interdigitated and interdigitated turbines. Such benefits may include preassembly of a counter-rotating interdigitated turbine rotor assembly (e.g., rotor assembly 100), or alternatively, preassembly of the rotor assembly and the gear assembly together, such as to allow for handling, movement, shipment, replacement, or maintenance separate from the gas generator 50. Benefits may additionally, or alternatively, include forming the gear assembly 300 separable from the rotor assembly 100, such as to allow for assembly and disassembly of the gear assembly separate from the rotor assembly 100 and gas generator 50. Furthermore, such benefits may allow for horizontal (i.e., along the axial direction A) assembly and disassembly, inspection, maintenance, or repair, of the gear assembly 300 and the rotor assembly 100. Horizontal assembly and disassembly may allow for on-aircraft (e.g., on-wing, on-fuselage, etc.) or in-situ assembly and disassembly of at least a portion of the engine, such as the interdigitated turbine rotor assembly and gear assembly, such as to improve engine maintainability and reduce cost of operation and ownership.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

1. A method for engine assembly, the method comprising forming an interdigitated rotor assembly comprising an inner rotor assembly rotatable at a first speed different from an outer rotor assembly rotatable at a second speed; fastening a gear assembly to the interdigitated rotor assembly to form an interdigitated turbine assembly; and coupling the interdigitated turbine assembly to a gas generator, wherein coupling the interdigitated turbine assembly to the gas generator comprises coupling a planet carrier assembly of the gear assembly to a static frame of the gas generator.

2. The method of any clause herein, wherein coupling the interdigitated turbine assembly to the gas generator comprises coupling the planet gear assembly to the static frame of the gas generator via a spline interface.

3. The method of any clause herein, wherein forming the interdigitated rotor assembly comprises fastening a bearing assembly to the inner rotor assembly.

4. The method of any clause herein, wherein fastening the bearing assembly to the inner rotor assembly comprises coupling a thrust bearing of the bearing assembly to a rotatable turbine frame; and coupling the rotatable turbine frame to the inner rotor assembly.

5. The method of any clause herein, the method comprising coupling the outer rotor assembly to the thrust bearing of the bearing assembly.

6. The method of any clause herein, the method comprising coupling a radial load bearing of the bearing assembly to the static frame of the gas generator.

7. The method of any clause herein, the method comprising coupling the thrust bearing of the bearing assembly to the planet carrier assembly of the gear assembly.

8. The method of any clause herein, wherein coupling the interdigitated turbine assembly to the gas generator comprises coupling a ring gear assembly of the gear assembly to a driveshaft of the gas generator via a coupling assembly.

9. The method of any clause herein, wherein forming an interdigitated rotor assembly comprises positioning an outer casing onto a first build fixture; then positioning a first stage inner turbine rotor onto the first build fixture; then positioning an outer drum rotor proximate to a trailing edge of the first stage inner turbine rotor; then installing a first stage outer turbine blade to the outer drum rotor; then fastening a second stage inner turbine rotor to the first stage inner turbine rotor to form the inner rotor assembly; then fastening one or more stages of a second outer turbine blade to the outer drum rotor; then fastening a bearing assembly to the inner rotor assembly; then fastening a rotatable turbine frame to the outer drum rotor to form the outer rotor assembly.

10. The method of any clause herein, wherein fastening the gear assembly to the interdigitated rotor assembly comprises coupling the rotatable turbine frame to a ring gear assembly of the gear assembly.

11. The method of any clause herein, the method comprising coupling the rotatable turbine frame to a thrust bearing of the bearing assembly.

12. The method of any clause herein, wherein forming an interdigitated rotor assembly comprises fastening a first bearing frame to the second stage inner turbine rotor; fastening a first bearing to the first bearing frame; fastening a rotatable sun shaft to the first bearing frame; fastening a second bearing frame to the first bearing frame; and fastening a second bearing to the second bearing frame.

13. The method of any clause herein, wherein coupling the interdigitated turbine assembly to the gas generator comprises fastening a second build fixture to the outer casing and the rotatable turbine frame; removing the first build fixture from the outer casing and the first stage inner turbine rotor; and fastening the outer casing to the gas generator.

14. The method of any clause herein, the method comprising fastening a rear static frame assembly to the outer casing.

15. The method of any clause herein, wherein fastening the gear assembly to the interdigitated rotor assembly comprises fastening a ring gear assembly onto the rotatable turbine frame; fastening a sun gear onto a rotatable mount frame of the bearing assembly; and coupling the planet carrier assembly to the sun gear and the ring gear assembly.

16. The method of any clause herein, the method comprising fastening a coupling assembly to the ring gear assembly and a driveshaft of the gas generator.

17. The method of any clause herein, the method comprising coupling a radial load bearing to the rotatable mount frame of the bearing assembly; and coupling the radial load bearing to the static frame of the gas generator.

18. The method of claim 4, the method comprising coupling a radial load bearing to the rotatable mount frame of the bearing assembly; and coupling the radial load bearing to the planet carrier assembly of the gear assembly.

19. The method of claim 4, the method comprising coupling a radial load bearing to the rotatable mount frame of the bearing assembly; and coupling the radial load bearing to a rotatable turbine frame of the outer rotor assembly.

20. The method of claim 1, wherein forming the interdigitated rotor assembly comprises fastening a bearing assembly to the inner rotor assembly; coupling one or more bearings of the bearing assembly to the outer rotor assembly to define the one or more bearings as one or more inter-rotor bearings coupled to the outer rotor assembly and the inner rotor assembly.

21. A turbomachine comprising the interdigitated rotor assembly formed by the method of any clause herein.

22. The turbomachine of any clause herein comprising the interdigitated turbine assembly formed by the method of any clause herein.

23. A turbomachine formed by the method of any clause herein.

24. A turbomachine comprising a gas generator, an interdigitated rotor assembly coupled to the gas generator by the method of any clause herein, and a gear assembly coupled to the interdigitated rotor assembly by the method of any clause herein.

25. The turbomachine of any clause herein comprising a fan assembly coupled to the interdigitated turbine assembly via the method of any clause herein.

26. A method for engine disassembly, the method comprising the method of any one or more steps herein.

27. A method for engine disassembly, the method comprising unfastening, uninstalling, or uncoupling any two or more components fastened, installed, or coupled by the method of any clause herein.

28. A method for interdigitated turbine assembly to an engine in-situ to an aircraft, the method comprising the method of any one or more steps herein.

29. A method for interdigitated turbine disassembly from an engine in-situ to an aircraft, the method comprising the method of any one or more steps herein.

30. A method for gear assembly to an engine in-situ to an aircraft, the method comprising the method of any one or more steps herein.

31. A method for gear disassembly from an engine in-situ from an aircraft, the method comprising the method of any one or more steps herein.

What is claimed is:

1. A method for engine assembly, the method comprising:
forming an interdigitated rotor assembly comprising an inner rotor assembly rotatable at a first speed different from an outer rotor assembly rotatable at a second speed;
fastening a gear assembly to the interdigitated rotor assembly to form an interdigitated turbine assembly; and
coupling the interdigitated turbine assembly to a gas generator, wherein coupling the interdigitated turbine assembly to the gas generator comprises coupling a planet carrier assembly of the gear assembly to a static frame of the gas generator.

2. The method of claim 1, wherein coupling the interdigitated turbine assembly to the gas generator comprises coupling the planet gear assembly to the static frame of the gas generator via a spline interface.

3. The method of claim 2, wherein forming the interdigitated rotor assembly comprises:
fastening a bearing assembly to the inner rotor assembly.

4. The method of claim 3, wherein fastening the bearing assembly to the inner rotor assembly comprises:
coupling a thrust bearing of the bearing assembly to a rotatable turbine frame; and
coupling the rotatable turbine frame to the inner rotor assembly.

5. The method of claim 4, the method comprising:
coupling the outer rotor assembly to the thrust bearing of the bearing assembly.

6. The method of claim 5, the method comprising:
coupling a radial load bearing of the bearing assembly to the static frame of the gas generator.

7. The method of claim 4, the method comprising:
coupling the thrust bearing of the bearing assembly to the planet carrier assembly of the gear assembly.

8. The method of claim 1, wherein coupling the interdigitated turbine assembly to the gas generator comprises coupling a ring gear assembly of the gear assembly to a driveshaft of the gas generator via a coupling assembly.

9. The method of claim 1, wherein forming an interdigitated rotor assembly comprises:
positioning an outer casing onto a first build fixture; then
positioning a first stage inner turbine rotor onto the first build fixture; then
positioning an outer drum rotor proximate to a trailing edge of the first stage inner turbine rotor; then
installing a first stage outer turbine blade to the outer drum rotor; then,
fastening a second stage inner turbine rotor to the first stage inner turbine rotor to form the inner rotor assembly; then
fastening one or more stages of a second outer turbine blade to the outer drum rotor; then
fastening a bearing assembly to the inner rotor assembly; then
fastening a rotatable turbine frame to the outer drum rotor to form the outer rotor assembly.

10. The method of claim 9, wherein fastening the gear assembly to the interdigitated rotor assembly comprises:
coupling the rotatable turbine frame to a ring gear assembly of the gear assembly.

11. The method of claim 10, the method comprising:
coupling the rotatable turbine frame to a thrust bearing of the bearing assembly.

12. The method of claim 9, wherein forming an interdigitated rotor assembly comprises:
fastening a first bearing frame to the second stage inner turbine rotor;
fastening a first bearing to the first bearing frame;
fastening a rotatable sun shaft to the first bearing frame;
fastening a second bearing frame to the first bearing frame; and
fastening a second bearing to the second bearing frame.

13. The method of claim 1, wherein coupling the interdigitated turbine assembly to the gas generator comprises:
fastening a second build fixture to the outer casing and the rotatable turbine frame;
removing a first build fixture from the outer casing and a first stage inner turbine rotor; and
fastening an outer casing to the gas generator.

14. The method of claim 13, the method comprising:
fastening a rear static frame assembly to the outer casing.

15. The method of claim 1, wherein fastening the gear assembly to the interdigitated rotor assembly comprises;
fastening a ring gear assembly onto a rotatable turbine frame;
fastening a sun gear onto a rotatable mount frame of a bearing assembly; and
coupling the planet carrier assembly to the sun gear and the ring gear assembly.

16. The method of claim 15, the method comprising:
fastening a coupling assembly to the ring gear assembly and a driveshaft of the gas generator.

17. The method of claim 4, the method comprising:
coupling a radial load bearing to a rotatable mount frame of the bearing assembly; and
coupling the radial load bearing to the static frame of the gas generator.

18. The method of claim 4, the method comprising:
coupling a radial load bearing to a rotatable mount frame of the bearing assembly; and
coupling the radial load bearing to the planet carrier assembly of the gear assembly.

19. The method of claim 4, the method comprising:
coupling a radial load bearing to a rotatable mount frame of the bearing assembly; and
coupling the radial load bearing to a rotatable turbine frame of the outer rotor assembly.

20. The method of claim 1, wherein forming the interdigitated rotor assembly comprises:
fastening a bearing assembly to the inner rotor assembly;
coupling one or more bearings of the bearing assembly to the outer rotor assembly to define the one or more bearings as one or more inter-rotor bearings coupled to the outer rotor assembly and the inner rotor assembly.
